(19) United States
(12) Patent Application Publication
(10) Pub. No.: US 2012/0127081 A1
(43) Pub. Date: May 24, 2012

(54) Methods of remote text input and editing on TV screen using locally-text-editable remote control

(76) Inventor: Guoxiang Lin, Potomac, MD (US)

(21) Appl. No.: 12/927,808

(22) Filed: Nov. 24, 2010

(51) Int. Cl. G06F 3/02

(52) U.S. Cl. 345/169

(57) ABSTRACT

A remote text input and editing method and a remote control device that allow user to input and edit text message on a hand-held remote control locally, and transmit the prepared text message to a television (TV). The remote text input and editing method involves batch text transmission, as opposed to traditional character-by-character remote control and remote keyboard approaches. Text messages transmitted between the remote control and the TV incorporates automatic error detection mechanism and can be in encrypted form.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention is directed to providing users with the capability to remotely input and edit text on a TV screen using a remote control which allows users to input and edit text message locally on the remote control, and to send the prepared text message to the TV screen.

Entertainment systems have become more and more interactive. TV set top box and digital video recorder provide searchable video on demand (VOD) functionalities, and newer TVs even come with internet browsing capability. However, when it comes to text input, like entering a movie title name for VOD, or entering information for a user profile on TV, or sending text messages to a friend on TV, remote text input posts a real challenge to current remote control devices.

There are two approaches for remote text input in the prior art, one using on-screen soft keypad, and the second using remote keyboard. The problem with these two approaches in the prior art is that both approaches can enter one character at a time only. For the first approach, users have to point the remote or move the highlight on screen to enter one character at a time, which is slow and hard to do when people sits 8 or 10 feet away from the screen. As to the second approach, not everyone can type correctly without looking at the keyboard. That means many users have to move the head up and down for each character. Even for people who can type traditional keyboard without looking at it, when they want to switch to a more convenient small keyboard, they may have to look at the keyboard while typing, since their fingers would be too big to rest on the small keyboard like the way with regular size keyboard.

What is needed is a system described in present invention, where user can input and edit text locally on a remote control, and is able to transmit the prepared text to a TV to display on its screen.

### BRIEF SUMMARY OF THE INVENTION

It is an object the present invention to provide users with an improved remote text input and edit capability on television (TV) using a remote control, utilizing batch text transmission.

In accordance with an embodiment of the present invention, a locally-text-editable remote control with batch text transmission capability allows users to type and edit text right on the remote control, and send the whole finished text to a TV to display on its screen. The remote control and the TV can communicate with each other using two-directional traffic means. The remote control operates in two modes—local text editing mode and remote control mode. And it can switch mode manually or automatically. The text transmission between the remote control and the TV has automatic error detection mechanism to ensure accurate text transmission. Text messages transmitted between the remote control and the TV can be in encrypted form.

### BRIEF DESCRIPTION OF THE SEVERAL VIEWS OF THE DRAWING

FIG. 1 is a block diagram of an entertainment system suited for incorporating an embodiment of the present invention.

FIG. 2 is a diagram illustrating a text message format in accordance with an embodiment of the present invention.

FIG. 3 is a diagram of a remote control for local text editing and batch text transmission in accordance with an embodiment of the present invention.

FIG. 4 is a sequence diagram illustrating remote text input and editing operations in accordance with an embodiment of the present invention.

### DETAILED DESCRIPTION OF THE INVENTION

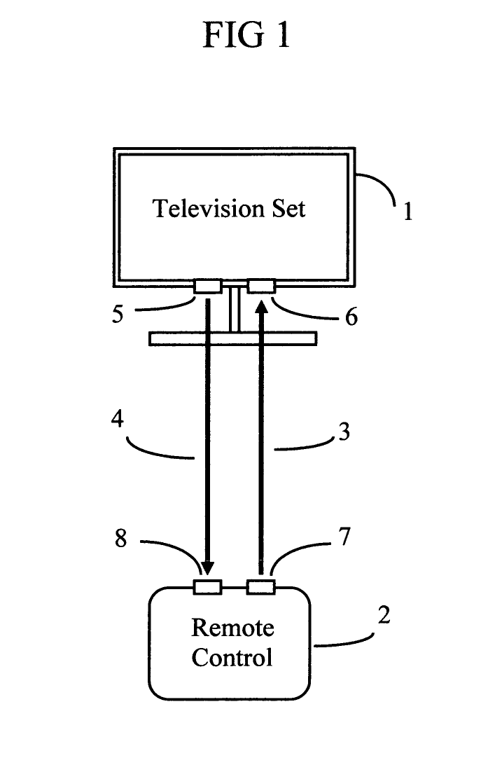

Referring to FIG. 1, a block diagram illustrates an entertainment system suited for incorporating an embodiment of the present invention. A television set 1 has a transmitter 5 to send signal and a receiver 6 to receive signal. A remote control 2 has a transmitter 7 to send signal and a receiver 8 to receiver signal. The communication between television set 1 and remote control 2 is two directional. Signal can be sent in direction 3 from remote control 2 to television set 1. Signal can also be sent in direction 4 from television set 1 to remote control 2. Although one-directional communication in direction 3 from remote control 2 to television set 1 can transmit prepared text message from remote control 2 to television set 1 in accordance with an embodiment of the present invention, two-directional communication provides means for more reliable and convenient remote text input and editing. Although a direct communication between a television set 1 and a remote control 2 is described in this illustrative system, it will be apparent that a system having a separate television receiver, e.g. a set-top box, which is connected to a television set 1 and communicates with a remote control 2, is also suited for incorporating an embodiment of the present invention.

Referring to FIG. 1, in this illustrative example, communication between television set 1 and remote control 2 uses radio frequency (RF) as transportation means to carry information being transmitted between television set 1 and remote control 2. It will be apparent to those skilled in the art that other transportation means, including, but not limited to, infrared (IR), can also be used for communication between television set 1 and remote control 2 in accordance with an embodiment of the present invention. Text message can be sent in direction 3 from remote control 2 to television set 1, and can be sent in direction 4 from television set 1 to remote control 2.

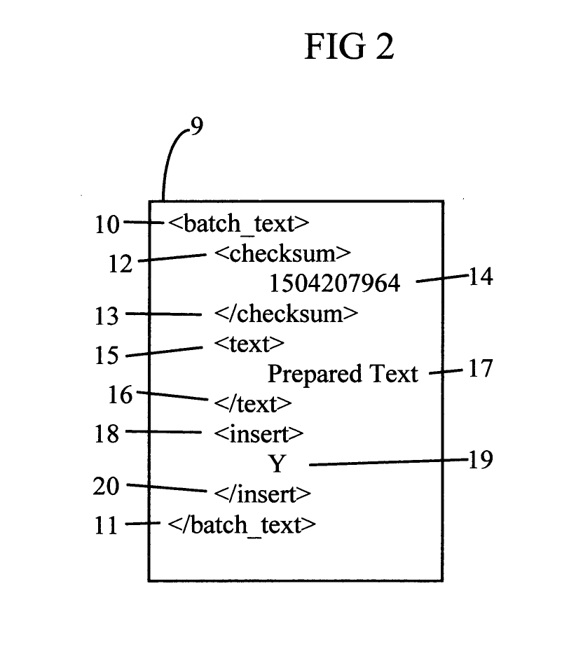

Referring to FIG. 2, a diagram illustrates a text message format in accordance with an embodiment of the present invention. As an illustrative example, XML format is used in text message transmission in direction 3 from remote control 2 to television set 1 and in direction 4 from television set 1 to remote control 2. Message 9 transmitted from remote control 2 to television set 1 is in XML format. Message 9 starts with <batch_text> 10 and ends with </batch_text> 11. Inside message 9, checksum value 14 is enclosed by <checksum> 12 and </checksum> 13. Checksum value 14 is used to check the integrity of prepared text 17 that is enclosed by <text> 15 and </text> 16. INSERT/REPLACE indicator 19 enclosed by <insert> 18 and <insert> 20 can be either Y or N. If INSERT/REPLACE indicator 19 is Y, television set 1 inserts prepared text 17 to the current cursor position on the screen of television set 1. If INSERT/REPLACE indicator 19 is N, television set 1 replaces existing text of the current text input area on the screen of television set 1 with prepared text 17. Although XML format is used in this illustrative example, it will be apparent for those skilled in the art that other message formats can also be used to transmit text between television set 1 and remote control 2 in accordance with an embodiment of the present invention.

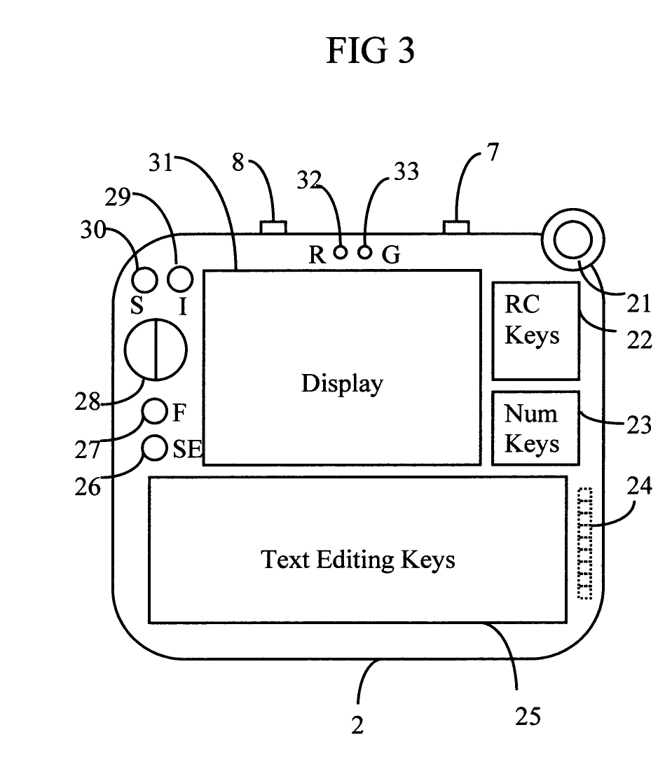

Referring to FIG. 3, a diagram illustrates a remote control for local text editing and batch text transmission in accordance with an embodiment of the present invention. Remote control 2 has transmitter 7 and receiver 8 for two-directional communication with television set 1. Remote control 2 operates in two modes—local text editing mode and remote control mode. In local text editing mode, text editing keys 25, number keys (Num Keys) 23, mouse buttons 28 and optical trackball 21 are used to input and edit text on display 31. In remote control mode, text editing keys 25, number keys (Num Keys) 23, mouse buttons 28 and optical trackball 21 are used to control television set 1. Remote control keys (RC Keys) 22 are used to control television set 1 regardless of the operating mode of remote control 2. SEND button (SE) 26 is used to send prepared text on display 31 to television set 1. Red light (R) 32 illuminates if sending the prepared text from remote control 2 to television set 1 failed. Green light (G) 33 illuminates if remote control 2 receives signal indicating that the prepared text was successfully sent from remote control 2 to television set 1. Once the prepared text is successfully sent to television set 1 by pressing SEND button 26, remote control 2 automatically switches to remote control mode and turns off display 31. Display 31 can be set to keep previously prepared text or to clear the buffer when it turns off. When remote control 2 receives TEXT_INPUT signal from television set 1, remote control 2 automatically switches to local text editing mode, and turns on display 31. Pressing SWITCH (SW) 30 one time will manually switch the operating mode of remote control 2 between local text editing mode and remote control mode. Pressing SWITCH 30 two times within 1 second will manually switch the operating mode of remote control 2, and, in addition, will turn off automatic mode switch function if the automatic mode switch function is currently on, or will turn on automatic mode switch function if the automatic mode switch function is currently off. INSERT button (I) 29 is used to toggle the value of INSERT/REPLACE indicator 19. Pressing FETCH button (F) 27 sends TEXT_RETRIEVAL command from remote control 2 to television set 1 to retrieve text from television set 1 to remote control 2. Remote control 2 has internal memory buffers 24 to store previously prepared text, which can be retrieved in a later time with MEMORY keys (not shown in the diagram). Remote control 2 has SYNC button (not shown in the diagram) to sync up with television set 1 and exchange public keys for encryption with television set 1.

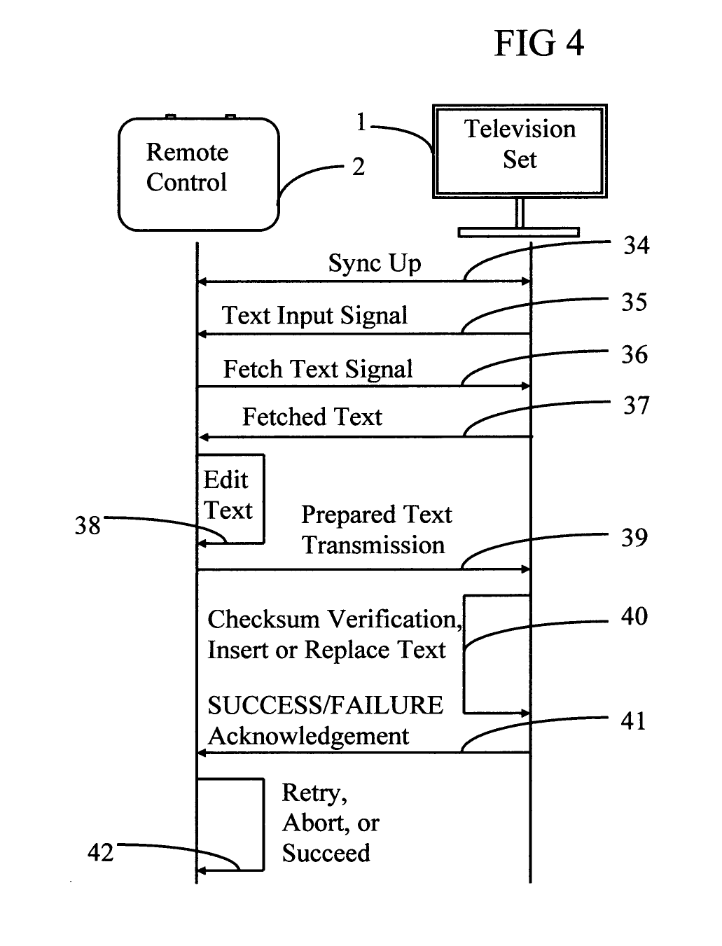

Referring to FIG. 4, a sequence diagram illustrates an example of steps practiced in implementing an embodiment of the present invention. In step 34, when user press both SYNC button of remote control 2 and SYNC button of television set 1 within a time period of 10 seconds, remote control 2 and television set 1 sync up with each other and exchange public keys, so that remote control 2 and television set 1 can communicate with each other with encrypted text message using asymmetric key algorithms. Although described using asymmetric key cipher for message encryption and decryption, it will be apparent for those skilled in the art that encryption techniques other than asymmetric key cipher could be used for encrypted text communication.

Referring to FIG. 4, in step 35, when television set 1 expects text input from remote control 2, television set 1 sends TEXT_INPUT signal to remote control 2. Upon receiving TEXT_INPUT signal from television set 1, remote control 2 switches to local text editing mode and turns on display 31. In step 36, user presses FETCH button 27 to send a TEXT_RETRIEVAL command from remote control 2 to television set 1. In step 37, television set 1 sends highlighted text on the screen of television set 1 to remote control 2. Alternatively, based on settings on television set 1 that are configurable using remote control 2, television set 1 sends existing text of current text input area on the screen of television set 1 to remote control 2. Remote control 2 inserts the fetched text into current cursor position on display 31. Alternatively, based on configurable settings of remote control 2, remote control 2 replaces existing text on display 31 with the fetched text, or stores the fetched text in a buffer of remote control 2. In step 38, user input and edit text on display 31, and may retrieve text from memory buffers to display 31.

Referring to FIG. 4, in step 39, user press SEND button 26; remote control 2 constructs an XML message, as illustrated by message 9, with the prepared text 17 from display 31, an INSERT/REPLACE indicator value 19 and a checksum value 14 of the prepared text 17; remote control 2 encrypts the XML message 9 and transmits the encrypted message to television set 1. In step 40, television set 1 decrypts the received message, and verifies the integrity of the prepared text 17 using the checksum value 14. If checksum verification of prepared text 17 is successful, television set 1 inserts prepared text 17 into the current cursor position on the screen of television set 1, or replaces the existing text of the current editable text area on the screen of television set 1 with the prepared text 17, based on the INSERT/REPLACE indicator value 19. And then, television set 1 sends SUCCESS acknowledgement to remote control 2 in step 41. If, in step 40, checksum verification of prepared text 17 is not successful, television set 1 drops the received message 9, and sends FAILURE acknowledgement to remote control 2 in step 41.

Referring to FIG. 4, in step 42, upon receiving SUCCESS acknowledgement from television set 1, remote control 2 illuminates GREEN light 33, switches to remote control mode, and turns off display 31. If remote control 2 receives FAILURE acknowledgement from television set 1, or does not receive any acknowledgement from television set 1 within 1 second, it will retry transmission of the same prepared text from step 39. If the second attempt of transmission fails again, remote control 2 will abort the prepared text transmission and will illuminate RED light 32. The number of retries before aborting the prepared text transmission is configurable. Pressing any key will reset RED Light 32 and GREEN Light 33 indicators. It will be apparent that remote control 2 can use other means to show status of the prepared text transmission in steps 39, 40, 41 and 42, including, but not limited to, other light colors and different sounds and tones. It will also be apparent that the encryption/decryption mechanism and the error detection and retry mechanism for text transmission from remote control 2 to television set 1, as illustrated in steps 39, 40, 41 and 42, can also be applied on text transmission from television set 1 to remote control 2, e.g. in step 37.

1. A method of remote text input and editing between a television set and a remote control of the said television set comprising the steps of:
Manually input characters on the said remote control to construct prepared text locally;
Transmit the said prepared text from the said remote control to the said television set;
Display the said prepared text on the screen of the said television set.

2. The method according to claim 1 further comprising the step of signaling the said remote control from the said television set for text input.

3. The method according to claim 1 further comprising the step of signaling the said television set from the said remote control for text retrieval to retrieve text from the said television set to the said remote control.

4. The text retrieval in claim 3 wherein the said television set transmits the highlighted text on the screen of the said television set to the said remote control.

5. The text retrieval in claim 3 wherein the said television set transmits the text in the current text editing area on the screen of the said television set to the said remote control.

6. The text retrieval in claim 3 wherein the retrieved text is transmitted in encrypted form from the said television set to the said remote control.

7. The text retrieval in claim 3 wherein the text transmission from the said television set to the said remote control employs error detection mechanism to verify the integrity of the said text received by the said remote control.

8. The text retrieval in claim 3 wherein the said remote control displays the said retrieved text on a local display of the said remote control.

9. The text retrieval in claim 3 wherein the said remote control stores the said retrieved text in a memory buffer of the said remote control.

10. The method according to claim 1 further comprising the step of editing the text on the said remote control.

11. The method according to claim 1 wherein the transmission of the said prepared text from the said remote control to the said television set employs error detection mechanism to verify the integrity of the said prepared text received by the said television set.

12. The error detection mechanism in claim 11 wherein the said remote control shows the status of the said transmission of the said prepared text.

13. The method according to claim 1 wherein the said prepared text is transmitted in encrypted form from the said remote control to the said television set.

14. The method according to claim 1 further comprising the step of clearing existing text on the screen of the said television set before displaying the said prepared text.

15. The method according to claim 1 wherein the said prepared text is inserted into the current cursor position on the screen of the said television set.
